(19) United States
(12) Patent Application Publication
(10) Pub. No.: US 2026/0138151 A1
(43) Pub. Date: May 21, 2026

(54) Device and Method for Applying and Curing a Polymer Layer on a Cylindrical Body

(71) Applicant: Maschinenfabrik Kaspar Walter Gmbh & Co. KG, Krailing (DE)

(72) Inventors: Christoph Gschossmann, Übersee (DE); Oliver Fechner, München (DE)

(21) Appl. No.: 19/119,473

(22) PCT Filed: Jul. 25, 2023
(86) PCT No.: PCT/EP2023/070607

§ 371 Date: Apr. 9, 2025

(30) Foreign Application Priority Data
Oct. 11, 2022 (DE) 10 2022 126 298.7

(51) Int. Cl. B05C 5/02; B05D 1/00; B05D 1/02; B05D 3/06

(52) U.S. Cl. CPC B05C 5/0241; B05D 1/002; B05D 1/02; B05D 3/067

(57) ABSTRACT

The invention relates to a layer producing system for producing a polymer layer on a cylindrical substrate (1), comprising a coating device (2) for coating the cylindrical substrate (1) with a flowable polymer and producing a still flowable polymer layer; a curing device (20) for curing the still flowable polymer layer on the substrate (1); a substrate receiving area for supporting the cylindrical substrate; a coating translation device for producing a translational movement of the coating device (2) relative to the substrate (1) in a longitudinal direction (X) of the substrate; a curing translation device for producing a translational movement of the curing device (20) relative to the substrate in the longitudinal direction (X) of the substrate; a rotational device for moving the substrate (1) supported in the substrate receiving area in a rotational direction (R); and a movement controller which is designed to coordinate the movements carried out by the two translation devices with the movement of the rotational device.

### TECHNICAL FIELD

The invention relates to a device and method for producing a polymer layer on a cylindrical substrate. In particular, the invention relates to a device and method for applying and curing such a polymer layer on the substrate.

### BACKGROUND

Such a substrate, for example, can be a printing plate that can be coated with a polymeric coating material. In the following text, the term “substrate” or “printing plate” will, in particular, be used as a generic term for gravure plates, letterpress plates or patterning plates for embossing, but also for coating rollers or inking rollers.

WO 2021/052641 A1 discloses a printing plate and a polymeric coating material for it. The coating material is a polymeric nanocomposite that can be designed as a single layer for printing plates. The polymeric nanocomposite is applied in flowable form to the cylindrical outer face of the printing plate and subsequently cured by irradiation with UV light. The resulting polymer layer, for example, can be patterned with the aid of infrared lasers in order to produce a surface pattern which, for example, has cells or patterns for ink absorption or for embossing, as this is also described in WO 2021/052641 A1.

The application and curing of a still flowable polymer, such as the nanocomposite mentioned above, is time-consuming. Curing should be carried out using UV light, in particular. In order to achieve an efficient and low-emission, i.e., ozone-free, curing process, UV LEDs are increasingly being used, which are dependent on inerting the surface due to the prevailing oxygen inhibition of the surface of the radical polymerization.

The requirements for the surface quality of the polymer coating are high, as this can directly influence the print quality if the cylindrical substrate is a printing cylinder, such as a gravure cylinder. An uneven polymer surface would result in a poor print image.

Coating a substrate with a polymer therefore requires a high degree of precision on one hand in order to produce the polymer layer with the appropriate quality.

This applies, in particular, when the polymer layer is applied to a printing plate, such as a gravure cylinder, as the quality of the polymer layer also influences the quality of the subsequent print. On the other hand, the coating must be applied efficiently and cost-effectively in order to be used in a print store, for example.

This also applies to the curing of the polymer after the coating process. It must be possible to cure efficiently and quickly.

### SUMMARY

The invention is therefore based on the object of specifying a layer producing system for producing a polymer layer on a cylindrical substrate, with which flowable polymer can be applied to the substrate and subsequently cured.

The object, in accordance with the invention, is achieved by a layer producing system and a method for producing a cured polymer layer. Advantageous configurations are specified herein.

A layer producing system for producing a polymer layer on a cylindrical substrate is specified, comprising a coating device for coating the cylindrical substrate with a flowable polymer and producing a still flowable polymer layer; comprising a curing device for curing a still flowable polymer layer on the substrate; comprising a substrate receptacle for bearing the cylindrical substrate; comprising a coating translation device for producing a translational movement of the coating device relative to the substrate in a longitudinal direction of the substrate; comprising a curing translation device for producing a translational movement of the curing device relative to the substrate in a longitudinal direction of the substrate; comprising a rotation device for moving the substrate borne in the substrate receptacle in a rotational direction; and comprising a motion control unit which is designed to coordinate the movements carried out by the two translation devices with the movement of the rotation device.

In particular, the coordination can achieve a relative spiral movement of the coating device or the curing device relative to the substrate surface.

With the layer producing system it is possible first to coat the curved surface area of the substrate with a polymer layer. To do this, the coating device moves relative to the surface of the substrate corresponding to a spiral path.

After the polymer has been applied, the curing takes place with the aid of the curing device, which also moves relative to the surface of the substrate corresponding to a spiral path. It is not necessary to reclamp the substrate in this process. Rather, the substrate can remain in the substrate receptacle, which rotates the substrate during the coating process and subsequently during the curing process.

The coating device and the curing device, in turn, are only moved in the longitudinal or translation direction. In addition, the respective functional heads (nozzle for applying the flowable polymer in the coating device; UV lighting device in the curing device) can also be moved with respect to their distance from the substrate or polymer surface, i.e., in the radial direction to the substrate, as will be explained later.

The coating device can therefore be moved relative to the rotating substrate. The translational direction, in particular, can be the longitudinal direction of the substrate, i.e., its central axis, for example, while the substrate itself is rotated around its main axis or central axis. The desired relative spiral movement can be achieved by the superimposed movement with the rotation of the substrate and the translation of the coating device. This allows the flowable material to be applied evenly to the surface of the substrate, forming a spiral path in this process, where the path elements should be placed next to each other without any gaps so that the remaining small gap can be easily closed by the action of a blade, e.g., a smoothing blade, which will be explained later. Ideally, the spiral movement can be set so precisely that there are practically no gaps between the adjacent layers.

Accordingly, the curing device for curing the polymer can also be moved relative to the rotating substrate. The translational direction, in particular, can be the longitudinal direction of the substrate, i.e., its central axis, for example, while the substrate itself is rotated around its main axis or central axis. The desired relative spiral movement can be achieved by the superimposed movement with the rotation of the substrate and the translation of the curing device. This allows the polymer to be cured evenly on the surface of the substrate. In particular, the polymer can be cured effectively and without gaps due to the resulting spiral path of the UV radiation.

The coating device can include: a supply nozzle for applying the material to a substrate; a smoothing blade which is arranged downstream of the supply nozzle and can be designed to smooth a surface of the material applied to the substrate; and a force generating device for applying a force to the smoothing blade; wherein the force that can be applied to the smoothing blade by the force generating device can be modified, and wherein the force generating device can include a force control unit for setting the force that can be applied to the smoothing blade by the force generating device.

The cylindrical substrate to be coated can be rollers of all kinds, in particular printing plates, such as gravure plates or cylinders, patterning plates or cylinders, embossing plates or cylinders, as well as letterpress plates or cylinders, or coating rollers, as well as inking rollers, e.g., for flexographic printing.

The flowable material can be a flowable polymer material, in particular.

For example, it can be a polymeric coating material as, for example, described in WO 2021/052641 A1. In particular, the polymer can be a coating material for coating a printing plate, including a liquid starting material that is polymerizable by UV light in order to form a polymer matrix, a filler having a sub-microscale size, wherein the coating material contains an additional filler in addition to the sub-microscale filler, wherein the sub-microscale filler is in particulate form and its size lies in a range between 100 nm and 999 nm, wherein the additional filler is a nanoscale filler such that the additional filler has filler particles having a nanoscale size in a range between 1 nm and 99 nm, wherein the sub-microscale filler consists of at least one metal oxide and/or a semi-metal oxide selected from metal oxide coated mica, TiO₂ or (Sn, Sb)O₂, wherein the nanoscale filler is metal and/or semi-metal oxides selected from Al₂O₃, SiO₂, TiO₂, ZrO₂ or organometallic particles, wherein the sub-microscale filler can be covalently integrated into a polymer matrix of the starting material, wherein the nanoscale filler is contained for increasing wear resistance and can be covalently integrated into the polymer matrix of the starting material, and wherein the sub-microscale filler in the starting material can effect an absorption of IR radiation which is higher than an absorption without a filler.

The smoothing blade is arranged downstream of the supply nozzle and is suitable for smoothing the layer of material applied to the substrate and, in this process, particularly for closing interstices and gaps that have formed between adjacent layers of material when applying the material.

For this purpose, the smoothing blade is pressed onto the layer of material with the aid of the force generating device, with the contact pressure being ideally adjusted. A too high contact pressure leads to a major change in the layer thickness distribution, while a too low contact pressure prevents the transition gap between the adjacent layers from closing. It has been shown that, due to different viscosities, surface tensions and other material variables, different surface pressures should be achievable by the smoothing blade.

The smoothing blade can be made of thin plastic sheet that can be deformed in an appropriate manner so that it adapts to the surface of the material to be smoothed.

The force generating device is designed to deflect the smoothing blade out of its rest position and move it. In this respect, the rest position is an initial position. With the aid of the force generating device and the force control unit coupled to it, the force applied to the smoothing blade by the force generating device can be precisely set so that the smoothing blade, in turn, is pressed onto the material to be smoothed with the appropriate force.

The layer thickness of the material, for example, can be 10 to 500 μm, in particular 10 to 250 μm, as the target layer thickness. The deviation from the target layer thickness should be minimal, and lie in a range of up to ±5% or up to ±3%, for example.

The curing device can include: a UV lighting device for producing UV light and providing the UV light at a light aperture; a curing gap which is arranged in front of the light aperture; an inert gas supply device for supplying inert gas to the curing gap upstream of the light aperture; an inert gas flow through the curing gap; and an oxygen measuring device for measuring the oxygen content in the inert gas downstream of the light aperture.

The polymer material was applied in an appropriate manner to the outer surface of the substrate before the curing process and is still flowable in this state, i.e., before curing.

The UV lighting device produces UV light that can exit at the light aperture and from there can directly reach the polymer layer to be cured on the substrate. For this purpose, the curing gap is arranged in front of the light aperture and forms a narrow inerting and irradiation channel. The formation of the curing gap or channel can be ensured with the aid of precise positioning of the curing device relative to the polymer surface (and thus the substrate surface), as will be explained later.

The curing gap is at least partially open towards the polymer layer to be cured. In particular, the curing gap is at least partially open on its side facing the substrate. The curing gap can have a gas inlet for admitting the inert gas and a gas outlet for discharging the inert gas. Within the curing gap itself, the light aperture is arranged opposite the polymer layer in order to enable curing of the polymer layer by irradiation with UV light.

The oxygen measuring device serves to measure the oxygen content in the inert gas discharged from the light aperture. In this process, the residual oxygen content in the inert gas is measured in particular. In order to achieve the desired protective effect of the inert gas on the polymer layer, the inert gas must have a specific concentration, which can be detected indirectly by measuring the residual oxygen content in the inert gas flow. For this purpose, the oxygen measuring device can include a lambda probe (λ probe). Based on the measurement results of the residual oxygen measurement, the required amount of inert gas can each be set and supplied on the upstream end via the inert gas supply device. This ensures that there is always a sufficient supply of inert gas within the curing gap during UV irradiation. On the other hand, it is also possible to prevent too much inert gas from being consumed so that the curing process can be carried out in an economic and resource-saving manner.

Nitrogen is particularly suitable as an inert gas, as it provides a sufficient inerting effect.

The curing device allows a polymer layer to be cured on a cylindrical substrate, regardless of the shape or format of the substrate.

As explained above, the coating device and possibly the curing device can move longitudinally along the curved surface area of the substrate parallel to the main axis of the cylindrical substrate.

The coating device and/or the curing device can each perform a spiral movement relative to the substrate. This results from the fact that the substrate can be rotated in the rotational direction, while the coating device and the curing device perform a translational movement on the longitudinal side of the substrate. The resulting relative movement then corresponds to a spiral movement. The spiral movement makes it possible that both the coating device, when applying the flowable polymer, and the curing device, when curing the polymer layer produced on the substrate, are able to coat the desired cylindrical surface of the substrate.

A coating positioning device for the coating device can be provided for positioning the coating device relative to the substrate in the radial direction of the substrate.

The coating positioning device can include a distance adjusting device, wherein the distance adjusting device can include a distance measuring device for measuring the distance between the coating device and the substrate, and wherein the distance adjusting device can include a distance setting device for setting the distance of the coating device to the substrate such that the distance corresponds to a predetermined value.

The distance measurement can be carried out in an inductive, capacitive or laser-supported manner, so that the distance can be adjusted variably and with mechanical precision. In this respect, the distance measuring device is a distance sensor.

Furthermore, a curing positioning device can be provided for the curing device for positioning the UV lighting device.

The curing positioning device, similar to the coating positioning device, can include a distance adjusting device, wherein the distance adjusting device can include a distance measuring device for measuring the distance between the curing device and the substrate, and wherein the distance adjusting device can include a distance setting device for setting the distance of the curing device to the substrate such that the distance corresponds to a predetermined value.

The distance measurement for the curing device can also be carried out in an inductive, capacitive or laser-supported manner, so that the distance can be adjusted variably and with mechanical precision. The distance measuring device is also a distance sensor in this case.

A method for producing a polymer layer on a cylindrical substrate is specified, comprising the steps of:
coating the cylindrical substrate with a flowable polymer and producing a flowable polymer layer;
curing the flowable polymer layer on the substrate;
bearing the cylindrical substrate in a substrate receptacle;
moving the coating device in a translational movement relative to the substrate in a longitudinal direction of the substrate during coating;
moving the curing device in a translational movement relative to the substrate in a longitudinal direction of the substrate during curing;
moving the substrate borne in the substrate receptacle in a rotational direction during coating and during curing; and
coordinating the two translational movements with the rotational movement of the substrate.

During the coating of the cylindrical substrate and during curing of the polymer layer, the substrate should be borne in an appropriate manner in the substrate receptacle so that the substrate surface is easily accessible.

### BRIEF DESCRIPTION OF THE DRAWINGS

These and additional features and advantages of the invention will be explained in more detail in the following text based on examples with the aid of the accompanying figures, in which:

FIG. 1 shows a coating system for applying a polymer layer to a cylindrical substrate;

FIG. 2 shows a coating device as part of the coating system of FIG. 1, for coating a cylindrical substrate with a polymer;

FIG. 3 shows a sectional side view of the device of FIG. 2;

FIG. 4 shows a detail enlargement “C” from FIG. 2;

FIG. 5 shows a curing system for curing a polymer layer on a cylindrical substrate;

FIG. 6 shows a curing device as part of the curing system of FIG. 5;

FIG. 7 shows a detail enlargement of the curing device of FIG. 6; and

FIG. 8 shows a sectional partial side view of the curing device of FIG. 6.

### DETAILED DESCRIPTION

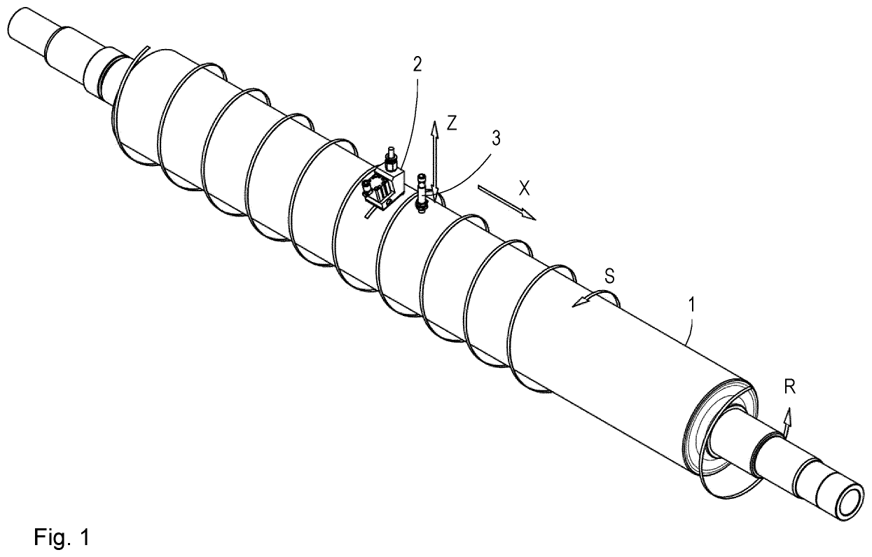

FIG. 1 shows a perspective view of a coating system as part of a layer producing system for producing a polymer layer on a cylindrical substrate 1.

In the example shown, substrate 1 is a printing plate, namely a gravure cylinder for use in gravure printing. The gravure cylinder is to be coated with a flowable polymer. This, for example, can be the nanocomposite known from WO 2021/052641 A1. The polymer coating of the gravure cylinder is suitable for creating small indentations, so-called cells, by laser treatment, in particular with a near-field infrared laser (NIR), which can absorb the printing ink and transfer it to the object to be printed. For this purpose, the polymer layer must have a relatively small thickness (layer thickness) of, for example, 10 μm to 500 μm, in particular 10 μm to 250 μm.

The substrate 1 or the gravure cylinder is held so that it can rotate in a rotational direction R in a receptacle not shown.

A coating device 2 is provided on the outer face of the substrate 1, which can be moved in a translational direction X along the outer face of the substrate 1. The coating device 2 serves to apply the still flowable polymer material to the cylindrical curved surface area of the substrate 1.

When the translational movement of the coating device 2 in the translational direction X and the rotation of the substrate 1 in the rotational direction R are superimposed, the coating device 2 performs a spiral movement relative to the outer face of the substrate 1, as shown in FIG. 1 by arrow S. This allows flowable polymer material with a width of, e.g., several millimeters, e.g., 5 mm to 30 mm, to be applied to the outer face of the substrate 1 with the aid of the coating device 2. Due to the relative spiral movement, one polymer layer can be applied next to the other in a spiral or helical manner, so that ultimately the entire curved surface area of the substrate or part thereof is uniformly covered with a polymer layer. With the aid of smoothing elements, which will be explained later, a gap that arises between the adjacent polymer layers in this process can be uniformly closed so that an even, homogeneous polymer layer is created.

To apply the polymer material, it is necessary for the coating device 2 to maintain a uniform, very close distance to the substrate surface. For this purpose, the coating device 2 can be moved in the radial direction Z of the substrate 1 by a coating positioning device not depicted. For this purpose, the coating positioning device can include a distance adjusting device with a distance measuring device 3. Depending on the design, the distance measuring device 3 can operate in an inductive, capacitive or laser-supported manner as a distance sensor and support distance adjustment.

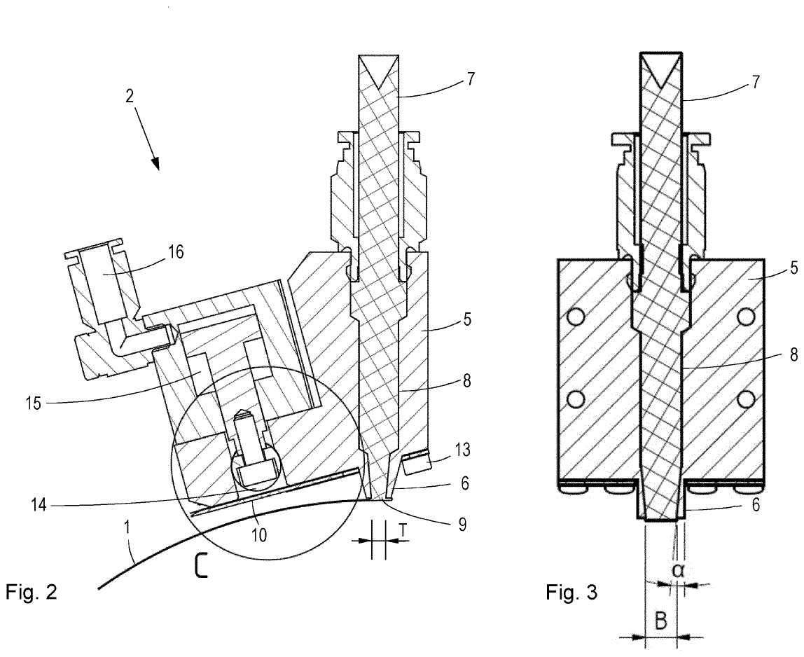

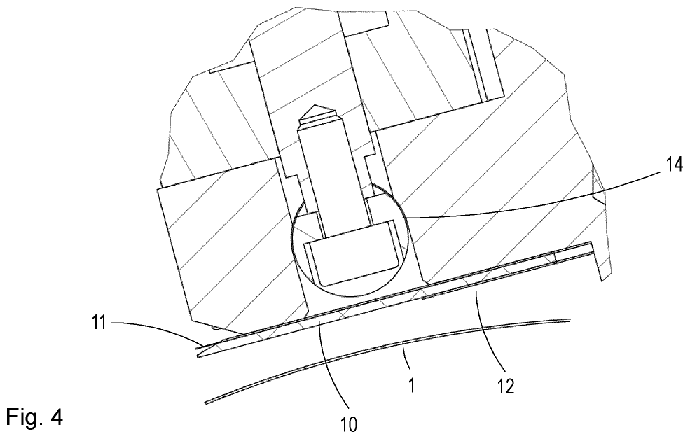

FIGS. 2 to 4 show the coating device 2 in detail, with FIG. 2 representing a main section, FIG. 3 a sectional side view of FIG. 2, and FIG. 4 a detail enlargement C of FIG. 2.

The coating device 2 has a carrier body 5. A supply nozzle 6 is held in the carrier body 5, to which coating material 7 is supplied in the form of flowable polymer material. The coating material 7 can be supplied by a continuous, pulsation-free and precise material conveyance, e.g., with the aid of syringe pumps or eccentric screw pumps (dispensers).

The supply nozzle 6 has a cylindrical material supply 8, which tapers conically towards an outlet opening 9. The outlet opening 9 can have a depth T of, e.g., 1 to 3 mm and a width B of 5 to 30 mm, although other dimensions are also possible.

In addition, the supply nozzle 6 can taper towards the outlet opening 9 (material outlet) with a taper angle. A taper angle α of, e.g., 1° to 7° ensures a laminar flow and an increasing fluid velocity of the coating material 7 shortly before the material exits.

It has been found that a sufficiently large meniscus or a sufficiently large heel at the nozzle outlet is produced at distances of the supply nozzle 6 or, in particular, the outlet opening 9 of the supply nozzle 6 to the substrate 1 in the range of 1×S to 4×S, wherein S is the desired layer thickness on the substrate 1, whereby complete wetting across the entire nozzle width is ensured. With a constant distance, a constant layer thickness is therefore also achieved.

Seen in the rotational direction downstream of the supply nozzle 6, a smoothing blade 10 is fastened to the carrier body 5 in order to smooth the surface of the polymer material applied to the substrate 1. The smoothing blade 10 can be a plastic sheet, for example. The plastic surface of the smoothing blade 10 is well suited for achieving the desired surface quality on the smoothed-out polymer.

A support blade 11 is arranged on the rear side of the smoothing blade 10 across the entire rear surface of the smoothing blade 10. The support blade 11 can be made of spring steel. The support blade 11 therefore supports the shape of the smoothing blade 10 and ensures a sufficiently high pressing force by the smoothing blade 10 on the polymer to be smoothed or spread.

FIG. 4 shows an enlarged view of the smoothing blade 10 and the support blade 11.

At the front side of the smoothing blade 10, a reset blade 12, which is also made of steel or spring steel, is provided, which extends across a partial surface of the smoothing blade 10 (FIG. 4). For example, the reset blade 12 can extend over half or a third of the surface of the smoothing blade 10.

The blades 10, 11, 12 are fastened together laterally to a blade fastening 13 on the carrier body 5.

A pressure piston 14 is provided on the rear side of the smoothing blade 10, which is acted upon and moved by a pneumatic cylinder 15, which, in turn, is controlled with compressed air via a pneumatic supply 16. The compressed air in the pneumatic cylinder 15 can be used to press the pressure piston 14 downwards against the support blade 11 and thus against the smoothing blade 10, thereby pressing the support blade 11 with the smoothing blade 10 against the reset blade 12. The reset blade 12 exerts a counterforce against the action of the pressure piston 14, so that a balance of forces is established depending on the air pressure applied. This allows the contact pressure of the smoothing blade 10 against the polymer material to be smoothed to be precisely set.

The contact pressure of the smoothing blade 10 on the applied polymer layer can be set with the aid of an adjusting unit. A too high contact pressure leads to a major change in the layer thickness distribution, while a too low contact pressure prevents the transition gap between the individual spiral coatings from closing. It has been shown that, due to different viscosities, surface tensions and other material variables, it must be possible to achieve a range of surface pressures of the smoothing blade 10 on the polymer material.

The width of the smoothing blade 10 can be two to three times or up to five times or up to ten times the width of a spiral layer in order to ensure a large support surface and an even layer homogenization.

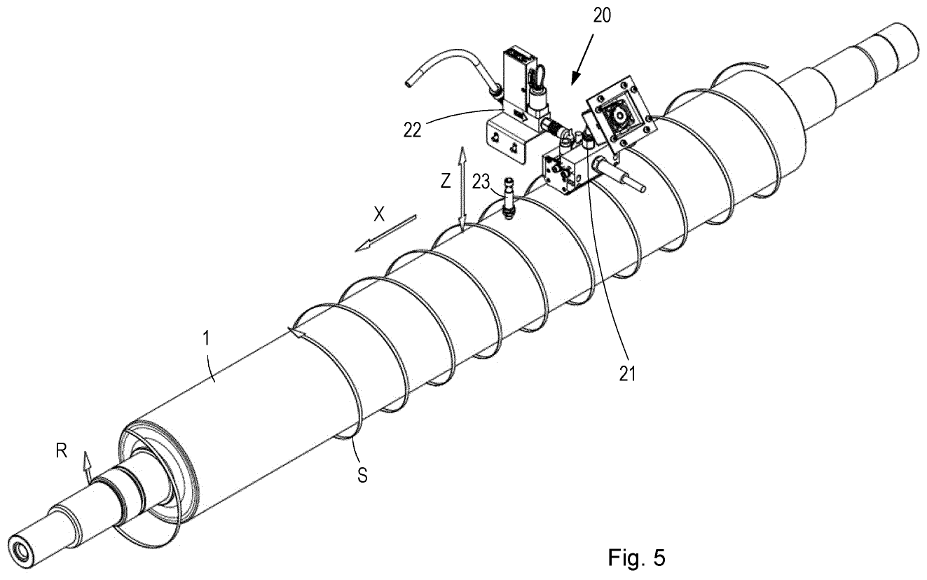

FIG. 5 shows a curing system as an additional part of the layer producing system for producing a polymer layer on a cylindrical substrate. The components shown in FIG. 5, in particular, can be a supplement to the components shown in FIG. 1, so that the entire layer producing system combines the components of FIGS. 1 and 5, i.e., firstly the application of a layer of a flowable polymer on the substrate 1 and thereafter the curing of the polymer layer on the substrate 1.

In the curing system of FIG. 5, it is accordingly assumed that the substrate 1 is already covered with a flowable polymer layer, which then, however, must still be cured in order to become dimensionally stable and to be able to serve its actual purpose, e.g., as a gravure roller.

The substrate 1, e.g., the gravure roller, is—as in the system of FIG. 1—still held in the receptacle not depicted and rotated in the rotational direction R.

A curing device 20, which cures the polymer layer with the aid of UV light, is arranged on the circumference of the substrate 1.

The entire layer producing system built with components of FIGS. 1 and 5 can therefore include the coating device 2 shown in FIG. 1 and the curing device 20. This means that a polymer layer can first be applied to the curved surface area of the substrate 1 by the coating device 2 and subsequently be cured by the curing device 20 with the aid of UV light irradiation. In both process steps, the substrate 1 can be rotated around its main or longitudinal axis, while the coating device 2 on one hand and the curing device 2 on the other hand are moved along the curved surface area.

When polymers are UV cured using LEDs, there is a risk that the free radicals of the photoinitiator released by the UVA radiation of the LEDs are bound by the atmospheric oxygen, thus preventing complete surface curing. For this reason, UV irradiation must take place in an inert gas atmosphere. In order to achieve this, the curing device 20 not only has a UV lighting device 21, but also an inert gas supply device 22.

Analogous to the coating device 2 in FIG. 1, the curing device 20 also has a curing translation device, not shown, with which the curing device 20 can be moved in a translational direction X along the longitudinal axis of the substrate 1. Parallel to this, the substrate rotates in the rotational direction R, resulting in the spiral movement S. In this way, the curing device 20 with the UV lighting device 21 can coat the entire surface of the polymer layer applied to the curved surface area of the substrate 1 and in this way cure the polymer.

Analogous to the coating device 2 described above, the curing device 20 also has a curing positioning device, not depicted, with a distance adjusting device in order to be able to set the distance of the curing device 20 in the direction Z, i.e., in the direction of the surface of the substrate 1 (radial direction of the substrate 1). A distance measuring device 23 is provided for this purpose. Precise maintenance of the distance is important in order to be able to achieve a satisfactory curing result.

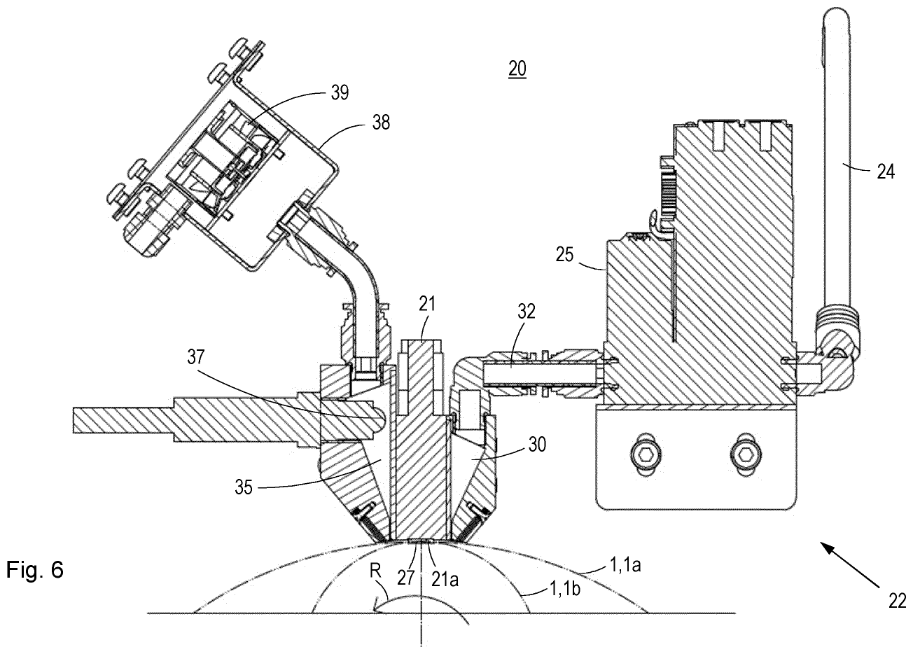

FIG. 6 shows the curing device 20 in an enlarged sectional view. The curing device 20 is depicted in relation to two substrates 1a, 1b of different sizes in order to illustrate that the curing device 20 can be used for substrates 1 with significantly different diameters.

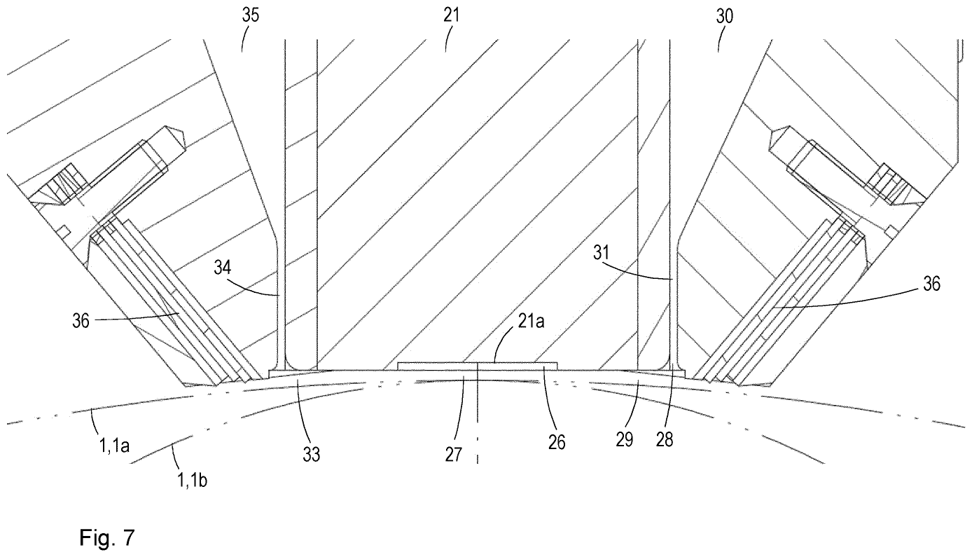

The curing device 20 has the UV lighting device 21 approximately in the middle, which is arranged vertically in the example shown and on the underside of which the UV light can exit via a light aperture 21a (FIG. 7), as will be explained later.

The inert gas supply device 22 arranged to the right of the UV lighting device 21 in FIG. 6 includes a gas supply line 24, via which inert gas is supplied from a storage tank, e.g., a gas cylinder or a gas tank. Nitrogen is particularly suitable as an inert gas. The flow of the inert gas to the light aperture 21a of the UV lighting device 21 is adjusted by a mass flow adjusting unit 25. This will be explained in detail later.

FIG. 7 shows the area underneath the UV lighting device 21 in an enlarged view compared to FIG. 6. The light aperture 21a, which serves as the outlet opening of the UV lighting device 21 and at which the UV light exits in order to irradiate the polymer material, is covered by a UV-light transmissive quartz glass cover 26.

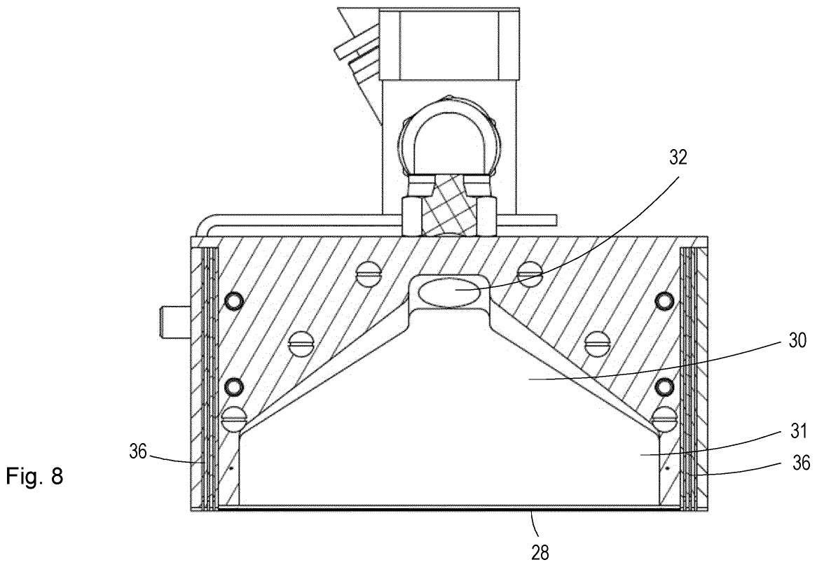

A curing gap 27 is formed between the UV lighting device 21 or the quartz glass cover 26 on one hand and the surface of the substrate 1 covered with the polymer layer at a distance therefrom on the other hand. Upstream of the quartz glass cover 26 and the curing gap 27, the inert gas supply device 22 has a flushing nozzle 28, via which the inert gas can be introduced into the curing gap 27 via a gas inlet 29. The flushing nozzle 28 is arranged on the end of a flushing funnel 30, to which a flushing channel 31 is connected, as shown in FIG. 8.

FIG. 8 shows a section through the flushing channel 31 of FIG. 7. It is clearly visible that the inert gas supplied by the mass flow adjusting unit 25 via a gas line 32 is fanned out in the flushing funnel 30 and subsequently calmed in the narrow flushing channel 31. An essentially laminar flow of the inert gas can be achieved in the flushing channel 31, which also serves as a calming section, so that the inert gas is discharged across the entire width of the flushing nozzle 28 and, in this process, can cover polymer material on the substrates 1a, 1b, before this area of the polymer material, which is then protected by inert gas, reaches the light aperture 21a on the quartz glass cover 26 in the curing gap 27, where UV irradiation takes place.

After leaving the flushing nozzle 28, it is to be expected that the inert gas will partially mix with atmospheric oxygen, as the area of the gas inlet 29 into the curing gap 27 cannot be completely sealed off from the environment. The curing gap 27 is therefore not passed through by pure inert gas, but by a gas mixture which, apart from inert gas, will also contain residual oxygen. The sealing measures provided to reduce the ingress of ambient air and the measures to achieve a predetermined proportion of inert gas in the gas mixture will be explained later.

Downstream of the quartz glass cover 26 or the curing gap 27, i.e., after UV irradiation, the curing gap 27 ends at a gas outlet 33. There, a gas discharge device 34 is provided with a measuring chamber 35 arranged downstream. The gas discharge device 34, in particular, can be designed as a gap and establish a connecting channel from the end of the curing gap 27 (gas outlet 33) to the measuring chamber 35. A portion of the inert gas is therefore discharged via the gas discharge device 34 or to the measuring chamber 35, while another portion of the inert gas that is not captured by the gas discharge device 34 can escape into the environment.

To reduce inert gas leakage or loss into the environment, the curing gap 27 is sealed on all sides, i.e., on all four sides, by non-contact seals, which, in particular, are designed in the form of blade seals 36. The blade seals 36 include one or more sheet metal elements which are arranged in a staggered arrangement and constitute flow obstacles so that the inert gas cannot flow outwards unhindered. In this way, and in conjunction with a gas conveying device, which will be explained later, it can be achieved that only a relatively small portion of the inert gas escapes into the environment, while the other part is extracted via the measuring chamber.

A lambda probe (λ probe) 37 is provided in the measuring chamber 35 as part of an oxygen measuring device. With the aid of the oxygen measuring device, the (residual) oxygen content in the inert gas downstream of the place of UV irradiation can be measured at the light aperture 21a. In this way, the inflow quantity of inert gas or the ratio of inert gas to oxygen can be adjusted with the aid of the mass flow adjusting unit 25 in order to keep the residual oxygen content within a predetermined range on one hand and thus also the inert gas content within a predetermined range on the other hand in order to ensure effective protection of the polymer surface against oxidation during the UV irradiation. Here, a residual oxygen content of 0.1% to 10%, in particular 0.5% to 5%, depending on the curing behavior of the polymer blend, has proven to be suitable.

The inert gas flow is effected with the aid of a gas conveying device 38, which has an extraction fan 39. The extraction fan 39 generates a vacuum with which the gas mixture is extracted from the inert gas supply device 22 via the curing gap 27. The gas flow thus takes place via the gas supply line 24, the mass flow adjusting unit 25, the gas line 32, the flushing funnel 30, the flushing nozzle 28, the curing gap 27, the gas discharge device 34, the measuring chamber 35, and the extraction fan 39.

1-10. (canceled)

11. A layer producing system for producing a polymer layer on a cylindrical substrate, the layer producing system comprising:
a coating device configured to coat the cylindrical substrate with a flowable polymer and produce a still flowable polymer layer;
a curing device configured to cure the still flowable polymer layer on the substrate;
a substrate receptacle configured to bear the cylindrical substrate;
a coating translation device configured to produce a translational movement of the coating device relative to the cylindrical substrate in a longitudinal direction of the cylindrical substrate;
a curing translation device configured to produce a translational movement of the curing device relative to the cylindrical substrate in the longitudinal direction of the cylindrical substrate;
a rotation device configured to move the cylindrical substrate in the substrate receptacle in a rotational direction; and
a motion control unit configured to coordinate the movements carried out by the coating translation device and the curing translation device with the movement of the rotation device,
wherein the cylindrical substrate is a printing plate selected from the group consisting of a gravure plate, a gravure cylinder, a patterning plate, a patterning cylinder, an embossing plate, an embossing cylinder, a letterpress plate, a letterpress cylinder, a coating roller, and an inking roller.

12. The layer producing system of claim 11, wherein the coating device comprises:
a supply nozzle configured to apply material to the cylindrical substrate;
a smoothing blade arranged downstream of the supply nozzle and configured to smooth a surface of the material applied to the cylindrical substrate; and
a force generating device configured to apply a force to the smoothing blade,
wherein the force generating device includes a force control unit configured to set the force applied to the smoothing blade by the force generating device.

13. The layer producing system of claim 11, wherein the curing device comprises:
a UV lighting device configured to produce UV light and provide the UV light at a light aperture;
a curing gap arranged in front of the light aperture;
an inert gas supply device configured to supply inert gas to the curing gap upstream of the light aperture;
an inert gas flow through the curing gap; and
an oxygen measuring device configured to measure oxygen content in the inert gas downstream of the light aperture.

14. The layer producing system of claim 13, further comprising:
a curing positioning device configured to position the UV lighting device.

15. The layer producing system of claim 14, wherein:
the curing positioning device includes a distance adjusting device;
the distance adjusting device includes a distance measuring device configured to measure a distance between the UV lighting device and a surface of the polymer layer and/or a surface of the cylindrical substrate;
the distance adjusting device includes a distance setting device configured to set the distance of the UV lighting device to the surface of the polymer layer and/or the surface of the cylindrical substrate such that the distance corresponds to a predetermined value.

16. The layer producing system of claim 11, wherein the coordination of the translational movement of the coating device and/or the curing device with the rotational movement of the cylindrical substrate causes, in each case, a spiral movement as a relative movement.

17. The layer producing system of claim 11, wherein the coating device and/or the curing device each perform a spiral movement relative to the cylindrical substrate.

18. The layer producing system of claim 11, further comprising:
a coating positioning device configured to position the coating device relative to the cylindrical substrate in the radial direction of the cylindrical substrate.

19. The layer producing system of claim 11, wherein:
the coating positioning device includes a distance adjusting device;
the distance adjusting device includes a distance measuring device configured to measure a distance between the coating device and the cylindrical substrate; and
the distance adjusting device includes a distance setting device configured to set the distance of the coating device to the cylindrical substrate such that the distance corresponds to a predetermined value.

20. A method for producing a polymer layer on a cylindrical substrate, wherein the cylindrical substrate is a printing plate selected from the group consisting of a gravure plate, a gravure cylinder, a patterning plate, a patterning cylinder, an embossing plate, an embossing cylinder, a letterpress plate, a letterpress cylinder, a coating roller, and an inking roller, the method comprising:
coating, via a coating device, the cylindrical substrate with a flowable polymer and producing a flowable polymer layer;
curing, via a curing device, the flowable polymer layer on the cylindrical substrate;
bearing the cylindrical substrate in a substrate receptacle;
during the coating, moving the coating device in a translational movement relative to the cylindrical substrate in a longitudinal direction of the cylindrical substrate;
during the curing, moving the curing device in a translational movement relative to the cylindrical substrate in the longitudinal direction of the cylindrical substrate;
during the coating and the curing, moving the cylindrical substrate in the substrate receptacle in a rotational direction; and
coordinating the translational movements with the rotational movement of the cylindrical substrate.
